(19) United States
(12) Patent Application Publication
(10) Pub. No.: US 2018/0218321 A1
(43) Pub. Date: Aug. 2, 2018

(54) ADVANCED DATE SELECTION SYSTEMS AND METHODS

(71) Applicant: Neopost Technologies, Bagneux (FR)

(72) Inventors: Justin Gabriel Cramer, Milwaukee, WI (US); Brian Larry Miller, Wauwatosa, WI (US)

(21) Appl. No.: 15/420,957

(22) Filed: Jan. 31, 2017

(51) Int. Cl. G06Q 10/08

(52) U.S. Cl. CPC G06Q 10/0834; G06Q 10/08345

(57) ABSTRACT

Improved systems and methods are provided for more dynamic and more accurate advanced date selection in parcel shipping. In an embodiment, a method includes the steps of receiving a shipment request including an origin date and a time, gathering carrier configuration data containing one or more of last trailer pull times, pickup inclusion or exclusion dates, transit inclusion or exclusion dates, and carrier delivery inclusion or exclusion dates, and returning the lowest cost carrier service that will meet the customer commitment time.

### BACKGROUND

The parcel shipping industry is experiencing marked growth and a surge in demand for services, and nowhere is this trend more evident than in the United States. According to a recent study analyzing parcel shipping volumes for business-to-business, business-to-consumer, consumer-to-business and consumer consigned shipments with weights up to 70 lb, for example, in 2015 alone, U.S. businesses shipped more than 11.8 billion units at a cost of over $85 billion, reflecting increases of 3.6% and 1.3%, respectively, over 2014.

This growth and surge in demand for services in the parcel shipping industry in the U.S., and globally, as well, is directly attributable to a dramatic rise in e-commerce and online sales. In 2015, e-commerce grew by nearly 15% in the U.S., and 20% globally, and online sales in the U.S. accounted for more than a third of total retail sales. Current forecasts project domestic e-commerce to continue to grow at this 15% pace through 2018, as compared to the 5%-7% for parcel shipping volumes. Global parcel shipping volumes are forecast to grow at a rate of 5%-7% annually, and up to 20% by 2018, as well.

The rise in e-commerce and online sales, in turn, is driving parcel shipping growth globally; it is shifting shipping power to the consignee (the consumer) from the carrier and the shipper; and, it is transforming the supply chain. It is also increasing competitiveness within the parcel shipping industry to provide preferred carrier and shipping services at the lowest cost that will meet the customer commitment time. While shippers and carriers readily recognize these increasing demands and the corresponding increase in competition, they are ill-equipped to evolve and to meet these demands.

Within the context of the present disclosure, and for clarity, a “shipper” refers to a person or company who is the supplier or owner of goods to be shipped. A “carrier” refers to a person or company that transports goods or people for any person or company. Similarly, a “carrier service” refers to a service offered by a carrier, and may also be referred to as a “carrier service level”. In the context of a shipper-carrier relationship, the shipper typically is considered to be the “customer”. As used herein, a “consignee” refers to a party shown on a bill of lading or an air waybill to whom a shipment is consigned or, more commonly, the recipient of a shipment.

### BRIEF SUMMARY

The present disclosure provides advantageous improved methods and systems for advanced date comparison and selection in parcel shipping.

According to an embodiment of the disclosed subject matter, an improved system is provided for dynamically and more accurately determining a parcel shipment delivery date including a network and at least one processor including memory coupled to the network. The processor may be configured to store and read carrier service level configurations including at least one of pickup dates, last trailer pull times, transit dates and delivery dates for each available carrier service, receive customer shipment requests, initiate requests and store responses for carrier service level cost information based upon the customer shipment requests, process the carrier service level configurations and carrier service level cost information to identify a lowest cost carrier service level capable of delivering the customer shipment within the customer commitment date, and transmit the identified available lowest cost carrier service level responsive to the customer shipment request.

According to an embodiment of the disclosed subject matter, an improved method is provided for dynamically and more accurately determining a carrier service capable of delivering a customer shipment within a customer commitment date at a lowest cost in response to a customer shipment request. The method may include one or more of the steps of storing and reading carrier service level configurations including at least one of pickup dates, last trailer pull times, transit dates and delivery dates for each available carrier service, receiving customer shipment requests over a network, and using at least one processor to process the customer shipment request. Processing of the customer shipment requests may include the steps of reading carrier service level configurations, initiating requests to and storing responses for carrier service level cost information based on the customer shipment requests, processing the carrier service level configurations and carrier service level cost information to identify a lowest cost carrier service level capable of delivering the customer shipment within the customer commitment date, and transmitting the identified available lowest cost carrier service level responsive to the customer shipment request.

According to an embodiment of the disclosed subject matter, an improved method is provided for dynamically and more accurately determining a shipment delivery date by receiving a shipment origin date and time, gathering carrier service level configuration data containing one or more of last trailer pull times, pickup inclusion or exclusion dates, transit inclusion or exclusion dates, and carrier delivery inclusion or exclusion dates, gathering carrier service level time in transit information and generating a delivery date using the shipment origin date and time, and carrier service level configuration data and the time in transit information. In generating a delivery date, the method may include determining a shipment pickup date. In determining a shipment pickup date, the method may include comparing the shipment origin date and time with the carrier last trailer pull times, and pickup inclusion and exclusion dates. In determining a shipment pickup date, the method also may calculate the next available pickup date by comparing the shipment origin date with the carrier last trailer pull times, and pickup inclusion and exclusion dates. In generating a delivery date, the method may evaluate all available transit dates from the shipment pickup date using at least one of transit inclusion and exclusion dates and the number of required transit days identified by the carrier.

According to an embodiment of the disclosed subject matter, a system is provided where a non-transitory computer-readable medium may use processor-executable instructions stored therein and configured to cause a processor to store and read carrier service level configurations including at least one of pickup dates, last trailer pull times, transit dates and delivery dates for each available carrier service, receive over a network and store customer shipment requests, initiate requests and store responses for carrier service level cost information based upon the customer shipment requests, process the carrier service level configurations and carrier service level cost information to identify a lowest cost carrier service level capable of delivering the customer shipment within the customer commitment date, and transmit the identified available lowest cost carrier service level responsive to the customer shipment request.

Additional features, advantages, and embodiments of the disclosed subject matter may be set forth or apparent from consideration of the following detailed description, drawings and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 is a schematic diagram illustrating an example of an advanced date selection system suitable for use with embodiments of the disclosed subject matter of the present invention.

FIG. 2 is a flowchart illustrating an example advanced date selection process according to an embodiment of the disclosed subject matter of the present invention.

### DETAILED DESCRIPTION

There is a need for parcel shipping technology to keep pace with the ongoing advances in e-commerce and online sales brought about by the Internet. Similarly, there is a need for shippers and carriers to improve and enhance shipping methodologies to keep pace with the rapid evolution in parcel shipping technology.

Others have recognized the shortcomings of current parcel shipping technology and the deficiencies in parcel shipping and delivery methods. See, e.g., U.S. Pat. No. 7,437,305 for “SCHEDULING DELIVERY OF PRODUCTS VIA THE INTERNET”, issued on Oct. 14, 2008; U.S. Pat. No. 8,615,473 for “METHOD AND SYSTEM FOR ANTICIPATORY PACKAGE SHIPPING”, issued on Dec. 24, 2013; U.S. Pat. No. 8,041,649 “METHODS AND SYSTEMS FOR POSTCODE-TO-POSTCODE DELIVERY INTERVAL AND ROUTING CALCULATION”, issued on Oct. 18, 2011; and U.S. Pat. No. 6,963,861 for “METHOD AND SYSTEM FOR RESOLUTION OF CARRIER SPECIFIC DATA UTILIZING A GENERIC DATA MODEL”, issued on Nov. 8, 2005.

As reflected at least in part in these illustrative patents, and in some commonly available commercial parcel shipping services, carriers typically provide customers (typically, shippers) with basic date selection options for package delivery to a given destination by a date certain. However, methodologies and services fail to enable more precise and accurate determination of parcel delivery dates and times that are within customer commitment date timeframes and at lowest costs, such as by offering, alone or in combination, any of multi-carrier services, precise parcel pickup dates, and consideration of any alteration(s) in “normal” pickup delivery or transit processes as provided by carrier or shipper contracts that may alter or change the typical delivery calculus.

Consequently, such existing methodologies and services fail to offer solutions that efficiently present and/or select customer service level agreements for parcel delivery, and may fail to minimize the money spent to meet the same customer service level agreement for delivery.

Such existing methodologies and services also may fail to maximize a customer's use of, e.g., USPS last mile services, ground services, and lower cost express services later into a delivery day.

Accordingly, there is a need for an improved advanced date selection system that provides more efficient shipment scheduling including date selection, multicarrier service options, and reduced cost for a given service level.

There is a need for an improved advanced date selection system that provides lowest cost shipment scheduling and accounts for variances in shipper or customer package pickup dates.

There is a need for an improved advanced date selection system that provides efficient and/or lowest cost shipment scheduling and accounts for shipper-specific variances that may alter “normal” pickup, delivery, and/or transit processes and, therefore, may change shipping delivery calculations.

There is a need for an improved advanced date selection system that minimizes the money spent to meet customer service level agreements for parcel shipment delivery.

There is a need for an improved advanced date selection system that enables a customer to maximize the use of USPS last mile services, ground service, and lower cost express service later into the day.

There is a need for an improved parcel shipment delivery system that dynamically and more accurately determines a parcel shipment delivery date that may include a network and at least one processor including memory coupled to the network, where the processor may be configured to store and read carrier service level configurations including at least one of pickup dates, last trailer pull times, transit dates and delivery dates for each available carrier service, receive customer shipment requests, initiate requests and store responses for carrier service level cost information based upon the customer shipment requests, process the carrier service level configurations and carrier service level cost information to identify a lowest cost carrier service level capable of delivering the customer shipment within the customer commitment date, and transmit the identified available lowest cost carrier service level responsive to the customer shipment request.

There is a need for an improved method for dynamically and more accurately determining a carrier service capable of delivering a customer shipment within a customer commitment date at a lowest cost in response to a customer shipment request that may include one or more of the steps of storing and reading carrier service level configurations including at least one of pickup dates, last trailer pull times, transit dates and delivery dates for each available carrier service, receiving customer shipment requests over a network, and using at least one processor to process the customer shipment request, and where processing of the customer shipment requests may include the steps of reading carrier service level configurations, initiating requests to and storing responses for carrier service level cost information based on the customer shipment requests, processing the carrier service level configurations and carrier service level cost information to identify a lowest cost carrier service level capable of delivering the customer shipment within the customer commitment date, and transmitting the identified available lowest cost carrier service level responsive to the customer shipment request.

There is a need for an improved method for dynamically and more accurately determining a shipment delivery date by receiving a shipment origin date and time that may include the steps of gathering carrier service level configuration data containing one or more of last trailer pull times, pickup inclusion or exclusion dates, transit inclusion or exclusion dates, and carrier delivery inclusion or exclusion dates, gathering carrier service level time in transit information and generating a delivery date using the shipment origin date and time, and carrier service level configuration data and the time in transit information.

There is a need for an improved parcel shipment delivery system that dynamically and more accurately determines a parcel shipment delivery date that may utilize a non-transitory computer-readable medium that may use processor-executable instructions stored therein and configured to cause the processor to store and read carrier service level configurations including at least one of pickup dates, last trailer pull times, transit dates and delivery dates for each available carrier service, receive over a network and store customer shipment requests, initiate requests and store responses for carrier service level cost information based upon the customer shipment requests, process the carrier service level configurations and carrier service level cost information to identify a lowest cost carrier service level capable of delivering the customer shipment within the customer commitment date, and transmit the identified available lowest cost carrier service level responsive to the customer shipment request.

The systems and techniques disclosed herein may address these needs, as well as providing solutions to other shortcomings and problems with current technologies, as well.

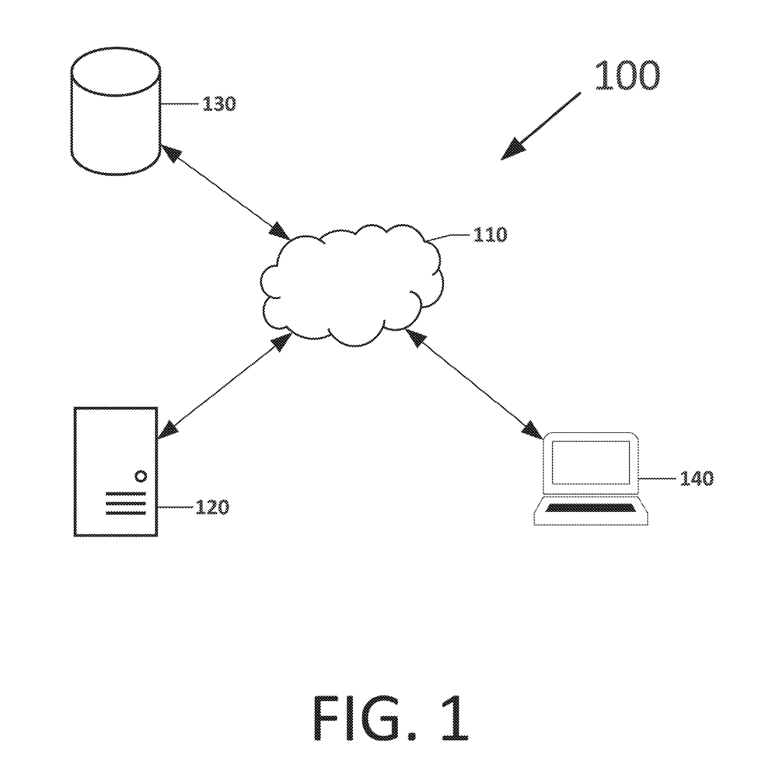

FIG. 1 schematically illustrates an exemplary system 100 that may implement an advanced date selection system for dynamically and more accurately determining a carrier capable of delivering a customer parcel shipment within a customer commitment date and/or at a lowest cost in accordance with the disclosed subject matter of the present invention. System 100 may include a processor 120 and at least one data store or database 130. A network 110 may be used to provide connectivity and communication among the various components of the system, and/or to connect the system 100 to other components and entities. System 100 may include one or more client hardware/software systems 140. Network 110 may include at least one of a wide area network (such as the Internet), a local area network (LAN), and a POTS (plain old telephone service) network (not shown). Processor 120 may include memory (also not shown).

System 100 may be configured in several ways. In an embodiment, system 100 may include one or more client hardware/software systems 140 for providing input to and receiving output from processor 120 and one or more data stores 130 for facilitating the output provided by processor 120. In an embodiment, system 100 may include one or more client hardware/software systems 140 and may be configured such that client systems 140 connect over network 110 to processor 120 and data store 130 where each of processor 120, data store 130 are connected to network 110. In an embodiment, system 100 may include one or more client hardware/software systems 140 and may be configured such that client systems 140 connect over network 110 to processor 120 and data store 130 where data store 130 is connected to processor 120. In an embodiment, system 100 may include more than one processor 120, more than one data store 130, and may further include a queuing service (not shown) for managing multiple distributed client systems 140, a load balancing system (also not shown) for managing multiple instances of processor 120 and for managing multiple distributed client systems 140, and each data store may be shared with each additional instance of processor 120. Still other configurations for system 100 will be known to those skilled in the art.

Processor 120 may be a CPU that resides on a PC or a server. Processor 120 may include volatile and non-volatile memory that executes code to perform functions. Processor 120 may execute code to perform functions including services that may be accessible from external systems. Processor 120 may include logic for performing functions for executing processes of the present invention. Processor 120 may host services for performing the functions in accordance with one or more embodiments of the present invention. Processor 120 may host a rating and delivery date assurance service.

Data store or database 120 may include a database or a series of files in a file system or in memory. Data store 120 may exist in volatile or non-volatile memory. Data store 120 may be accessible by processor 120. Data store 120 may be secure. Data store 120 may store one or more of carrier data and shipper data. Shipper data stores may store preloaded or predetermined customer data, including relevant shipper-carrier contract terms.

Carrier data stores may store third party carrier information including specific carrier service level data, which may include at least one of last trailer pull times, and pickup inclusion and exclusion dates, transit inclusion and exclusion dates, and delivery inclusion and exclusion dates.

Carrier data stores may also include service level times in transit and data necessary for calculating carrier costs. Service level times in transit and carrier costs also may be returned by a rating engine and may be calculated in real time.

As used herein, a “service level time in transit” refers to the number of transit days it takes a carrier service level to get a shipment from the origin to the destination, as defined by the carrier.

As used herein, a “transit date” refers to a date when a carrier service level is in operation and transits a package along the path from an origin to a destination or, in the vernacular, moves the shipment one day closer to the destination. In general terms, “transit dates” may be pre-negotiated and derived from contracts between carriers and shippers. Pickup dates may be pre-negotiated and contractually derived as well. Such contracts may define “transit dates” in terms of a date or a day of the week where a carrier service level will transit a package along the path from an origin to a destination (“inclusions”) (e.g., “from Monday and Friday between the hours of 8am-5pm”). Such contracts may define “transit dates” in terms of a date, day of the week or day and time of the week when a carrier service level will not transit a package along the path from an origin to a destination (“exclusions”) (e.g., “any day, except Thursdays”). Contract terms also may selectively include/exclude include holidays and weekends as “transit dates.”

A “last trailer pull time” refers to the time of day that a carrier will pull a last group of packages and still induct them for transit starting that day.

A “carrier pickup inclusion day” refers to a date or day of week when a carrier will pick up packages. Conversely, a “carrier pickup exclusion day” refers to a date or day of week when a carrier will not pick up packages.

A “carrier transit inclusion day” refers to a date or day of week when a carrier will transit a package along the path from the origin to the destination. Conversely, a “carrier transit exclusion day” refers to a date or day of week when a carrier will not transit a package along the path from the origin to the destination.

A “carrier delivery inclusion day” refers to a date or day of the week when a carrier will transfer custody of the shipment to the recipient. Conversely, a “carrier delivery exclusion day” refers to a date or day of the week when a carrier will not transfer custody of the shipment to the recipient.

Carrier (and shipper) data generally are updated daily or monthly, but may be updated at any desired interval or continuously within a given system. Updates may be triggered by contract renewal terms, or they may occur in accordance with other methods known to those skilled in the art.

Network 110 may include a local area network (LAN), a wide area network (WAN), i.e., the Internet, a metropolitan area network (MAN), and/or a POTS network. Processor 120 and data store 130 may connect via a LAN, a MAN or WAN.

Client system 140 may access system 100 via the Internet or a telephone service provided by a data center (not shown). Client system 140 may be local. Alternatively, client system 140 may be remote and may be one of an executable running on a PC, mobile device or a web-based application invoked remote from processor 120.

Processor 120 may be configured to store and read carrier service level configurations. Processor 120 may be configured to store and read customer configurations into and from data store 130, respectively. Processor 120 may be configured to receive customer shipment requests that include customer shipment data. Customer shipment data may include at least one of a shipment origin, a shipment destination, shipment weights, shipment dimensions and a customer commitment date, that being a date by which delivery must be completed. Shipment origin and destination information may comprise “time” elements of the customer shipment data. Shipment weight and dimension information, instead, may comprise “cost” elements of that data.

Those skilled in the art will recognize that customer shipment data may also include additional information, such as the value of the shipment, the contents of the shipment and additional services requested by the shipper. As those skilled in the art also will recognize, such additional information may influence the determination by a carrier of a shipment delivery date. For example, additional restrictions may be imposed on the shipment of hazardous materials/dangerous goods may excludes certain service options or change delivery time. Additional services requested by a shipper, such as “collect on delivery” may influence transit and delivery times, as well.

Processor 120 may be configured to initiate requests to and store responses for carrier service level cost information based upon the customer shipment requests. The requests for carrier service level cost information may be made to local data stores, to internal services over a network or to external third-party service providers over a network. Carrier service level cost information may include service level information and rate information. Carrier service level cost information may further include at least one of last trailer pull times, pickup inclusion or exclusion dates, transit inclusion or exclusion dates, and carrier delivery inclusion or exclusion dates. Processor 120 may transmit and receive requests for one or more of carrier service level configurations and carrier service level cost information from third party providers.

Processor 120 may be configured to process the carrier service level configurations and carrier information to identify available carriers capable of delivering the customer shipment within the customer commitment date. Processor 120 may be configured to transmit an identified available lowest cost carrier responsive to the customer shipment request.

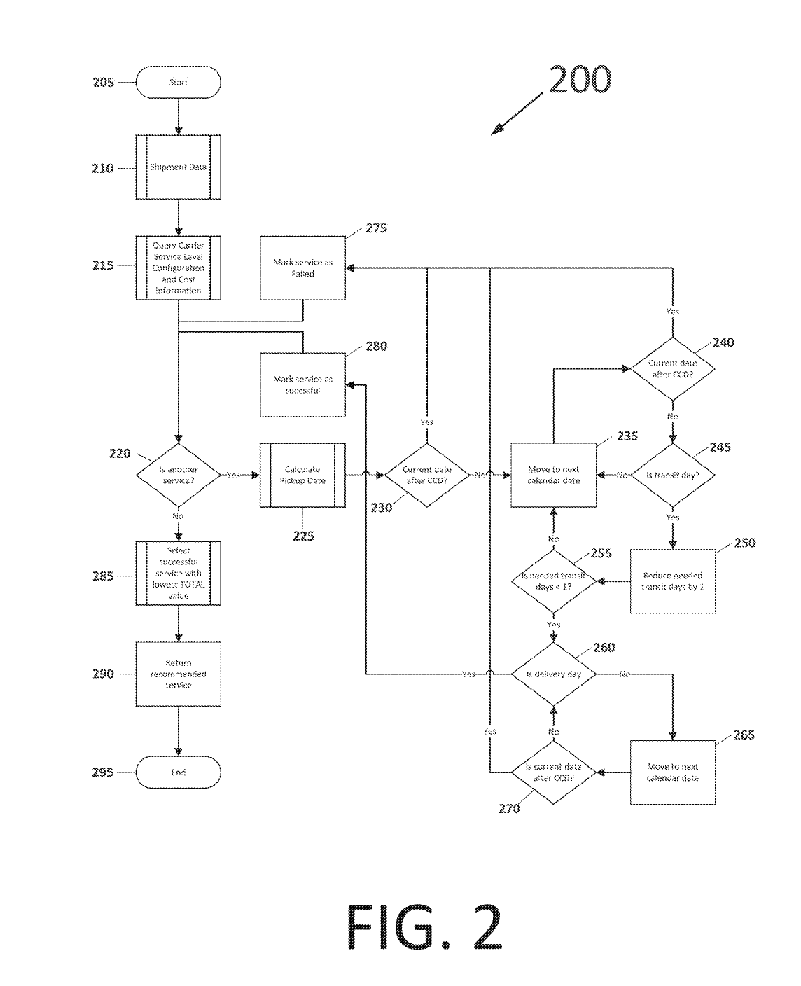

FIG. 2 illustrates an example method 200 as disclosed herein for dynamically and more accurately determining a carrier capable of delivering a customer shipment within a customer commitment date and/or at a lowest cost in response to a customer shipment request. In broadest terms, method 200 may begin when customer (shipper) shipment data reflecting a customer shipment request is received in processor 120. Processor 120 may use the shipment request data input to query a carrier data store 130 to determine carrier service level configuration information and may store the returned information. Processor 120 may then query carrier service level costs. These queries may be made to local data stores, to internal services over a network or to external third-party service providers over a network 110.

Processor 120 may then use current dates and times and last trailer pull times to calculate pickup dates for each carrier/carrier service level, for example by comparing a current date and time or a time of a shipment request to the last trailer pull times. Similarly, processor 120 may use current dates and times and transit inclusion/exclusion dates to determine the number of days needed to transit the shipment for each carrier/carrier service level. Processor 120 also may use additional shipment information such as the value of the shipment, the contents of the shipment and additional services requested by the shipper to determine the number of days needed to transit the shipment. Processor 120 may then use current dates and times and delivery inclusion/exclusion dates to determine a delivery date for each carrier/carrier service level. Processor 120 may then use shipper/customer shipment data and carrier service level cost information to determine the lowest cost carrier/carrier service level, and report it as the carrier/carrier service level recommended to fulfill the shipper/customer shipment request within the customer commitment date.

More particularly, method 200 may start at step 205 and begin at step 210 with detection by system 100 of a shipment request file input by a shipper/customer. Those skilled in the art will recognize that method 200 may be triggered by other events, such as, for example, by a pre-determined schedule or a customer-related query prior to a shipment request or purchase. However, method initiation based upon immediate detection of a shipment request may optimize the dynamic operation and responsiveness performance of system 100 and method 200 of the present invention. That is, a method 200 as disclosed herein may provide efficient shipment options in real time, immediately upon receiving a request from a shipper. As used herein, a process is performed in “real time” if there is no discernible delay in the process operating as observed by a user. One of skill in the art will understand that such a process may not operate instantaneously due to required processing time inherent in any computer-implemented system or process. However, a “real time” process generally does not have any additional delay due to other factors, such as waiting on additional inputs that are not immediately available within the system or from a remote system, waiting on human verification of a potential result, or the like.

Customer shipment data may be received in system 100 through any one of several input sources, including, e.g., ProShip Velocity®, ProShip Office° and ProShip SDK®, each a product of ProShip Inc., a Neopost® company.

In step 215, method 200 may query for carrier service level configuration and carrier service level cost information. Carrier service level configuration information may include at least one of pickup dates, transit dates, delivery dates and last trailer pull times for any carrier service level available for performing the requested shipment service. The carrier service level configuration information may be determined by queries made to local data stores, to internal services over a network or to external third-party service providers over a network, which may provide such information automatically and in real time in response to a request by a system 100 as previously disclosed. Carrier service level cost information may include at least one of time in transit and shipment cost. The carrier service level cost information may be determined by queries made to local data stores, to internal services over a network or to external third-party service providers over a network, and may be based at least upon customer shipment data time and cost elements.

The number of carriers and the levels of service offered by each carrier may be configurable. They may be pre-determined and pre-loaded loaded into the carrier rating engines. They also may be based upon and derived from the contractual terms between the carrier and the shipper. For example, a shipper may have negotiated specific levels of service and associated delivery times and costs with one or more carriers, which may vary between carriers for the same shipper. One skilled in the art will recognize that a combination of these sources may be used, as well.

The carrier service level configuration information inclusion and exclusion information preferably is supplemented and updated regularly. Updates of inclusion/exclusion dates, for example, may include adding Sunday as a delivery date for an express service or, where a natural disaster occurs, providing notice that pickups from a given origin warehouse will be delayed or diverted.

The carrier rating engines may calculate the carrier service level costs for all service levels to be considered. The server preferably returns the results in terms of “time” and “cost”. However, those skilled in the art will recognize that the cost and time in transit results may be returned in other manners as well, such as, for example, including a non-error as part of those results. Where a shipper seeks to ship to a residence, for example, rather than a commercial address, an additional relevant component of the service level time in transit results should indicate as “true” that the shipment destination may include “residential”. Such information may allow a carrier, e.g. FedEx Home Delivery® to return a cost and time as part of the service level time in transit results, rather than an error. Likewise, delivery to a particular location on a particular day may be limited to a particular service and may be returned as a non-error in service level time in transit results, where similar services may be excluded and may be returned as an error in those results, such as delivery on a weekend.

The carrier service level cost results (a.k.a. “rating results”) may include the service levels available for every carrier in the carrier service engines. While the carrier name may be included with each level of service shown, the rating results shown may be preferably based on the services that are offered that correspond with the inputted customer shipment date parameters.

In general terms, available carrier pickup dates may be standard service levels available to all shippers. Alternatively such terms may be pre-negotiated and derived from contracts negotiated between carriers and shippers. Such contracts may define carrier pickup dates in terms of a date, day of the week or day and time of the week when a carrier/service level will pickup packages (“inclusions”) (e.g., “from Monday and Friday between the hours of 8am-5pm”). They may also define carrier pickup dates in terms of a date or day of the week when a carrier/service level will not pickup shipments (“exclusions”) (e.g., “any day, except Thursdays”). Contract terms may also selectively include/exclude include national and local holidays and weekends as carrier pickup dates.

In step 220, method 200 may assess the availability of carrier service levels for shipment fulfillment. Typically, there will be at least one carrier service level available for determining if the carrier service level is capable of completing a shipment within the customer commitment date.

In an embodiment of the present invention, step 215 may yield only one carrier service level with the potential to complete a shipment within the customer commitment date, and the method may provide that the carrier service level is selected as the successful service in step 285 reported to the shipper as the recommended service in step 290 and the process is ended at step 295.

Alternatively, step 215 may yield one or more carrier service levels with the potential to complete a shipment within the customer commitment date, and the method 200 may continue to step 225.

Where step 215 yields no carrier service level with the potential to complete a shipment within the customer commitment date, then the result may be reported to the shipper in step 290 and method 200 may end at step 295.

In step 225, method 200 may calculate a shipment pickup date. The pickup date may be, but is not always and need not be the same day that the customer shipment data is received. Pickup dates may be calculated serially for each potential service and the calculated iteratively until all carrier service level options are queried. Alternatively, pickup date for all prospective carriers may be determined concurrently in parallel. However, independent and iterative carrier evaluation may be preferable not only in accordance with the disclosure with the present invention but also as such evaluation accords best with any variances in carrier industry practices such as, for example, making “special pulls” for a particular service and providing separate trailers for separate levels of service (e.g., FedEx® picks up Express, Ground, and SmartPost® in separate trailers) and having minimum pre-departure times for dutiable export shipments to provide sufficient time for customs clearance.

Steps 225 through 280 also may be determined all at once using a multi-threaded process.

Method 200 may provide that a pickup date may be calculated by determining if the customer shipment data receipt date is a carrier pickup date, as provided by the terms of the contract negotiated between the carrier and the shipper or according to standard terms provided by the carrier. The pickup date calculation may be made by checking the time when the customer shipment data is received against the “last trailer pull” for each available carrier/service level identified in the rating list returned step 215—whichever is more specific according to carrier service terms. For example, FedEx° may provide general “last trailer pull time” service terms (e.g., the “last trailer pull time” for all services is 5pm daily) or more specific “last trailer pull time” service terms depending on the service level offering (e.g., the “last trailer pull time” for FedEx First Overnight® is 3 pm the daily, and the “last trailer pull time” for FedEx° Ground is 5 pm daily).

In calculating the pickup date, if the time of day that a customer shipment request is received is later than a carrier/service “last trailer pull”, then that day is not a pickup date, the target pickup date may be moved to the next calendar day and the pickup date check may be done again to determine if the next calendar day, in fact, is a pickup date.

If the time of day that the customer shipment request is received is not later than a carrier/service “last trailer pull”, and if the day is not a pickup exclusion day or is a specific inclusion date to override a general exclusion, then the current day may be a pickup date.

In step 230, method 200 may compare the pickup date to the customer commitment date. At 275, any carrier service level having a pickup date after the customer commitment date may be marked as “failed”, as the process may selectively exclude “same day” shipment requests. Alternatively, such “same day” shipment requests may be encompassed as well.

Where step 230 yields a carrier service level not having a pickup date before the customer commitment date, then the customer shipment request may be marked as failed in step 275.

Where step 230 yields a carrier/service level having a pickup date that is before the customer commitment date, then that carrier/service level may remain a potentially viable recommended service option and method 200 continues to step 235.

In step 235, method 200 may invoke a loop methodology that begins by using the pickup date to initialize a “loop index date”. The loop methodology may decrement the number of shipment transit days required to determine if there are enough transit days available between the pickup date and the customer commitment date to complete delivery of the shipment, and if the final transit day is a delivery date. Each date between the pickup date and the delivery date may be checked to ensure that it is a carrier transit date. If there are not enough days for a particular service to transit a package to delivery prior to the customer commitment date, the carrier service level may fail and accordingly may not be presented to a shipper as an available carrier service level.

The loop index date may be used to count the number of days a shipment is in transit. The loop methodology of method 200 may be successfully invoked by moving the pickup date forward in various increments.

For example, in step 235, in the first step of the loop, method 200 may advance the loop index date by one calendar date. In step 240, method 200 may compare the next calendar date to the customer commitment date. According to this example process, in any instance where step 240 yields a carrier service level where the next calendar date is after the customer commitment date, the carrier service level may be marked as failed in step 275. Alternatively, where step 240 yields that the date in question is not after the customer commitment date, then method 200 may continue to step 245.

In step 245, method 200 may determine whether the next calendar date is a transit date. According to method 200, this determination may be made by comparing the next calendar date to the transit date(s). Where, in step 245, method 200 may determine that the next calendar date is a transit day for a carrier service level, then that carrier service level may remain a possible viable carrier service option and method 200 continues to step 250.

If the next calendar date is determined not to be a not transit day for a carrier service level at 245, then process 200 may revert to step 235 where the loop index date may be advanced another day and the loop may continue to analyze whether the next calendar date thereafter is within the customer commitment date (in step 240) and may be a transit day (step 245).

Where the next calendar date thereafter for a given a carrier/carrier service level is within the customer commitment date (step 240), and is a transit day (step 245), that carrier/carrier service level may remain a possible viable carrier service option.

In step 250, method 200 may reduce the number of needed transit days. The “number of needed transit days” may be defined for each carrier service level identified by the carrier rating engines in response to the customer shipment data. At step 250, the number of needed transit days may be decremented by 1 as decrementing by a factor of 1 best approximates decrementing from day to day and provides the most rapid execution of method 200. Those skilled in the art will recognize that the methods disclosed herein may use other decrementing factors, as well.

At 255, the number of needed transit days remaining following step 250 may be determined. More particularly, the method 200 may assess whether the number of needed transit days following step 250 is less than 1. As described with respect to step 250, the assessment of step 255 may utilize a factor of 1 to provide a best approximation of decrementing from day to day and the most rapid execution of method 200. Those skilled in the art will recognize here, as well, that other decrementing factors may be used as well.

In step 255, where the remaining number of days needed in transit may be greater than or equal to 1 day for any carrier service level, method 200 reverts to step 235 and may move the next calendar date ahead one day, and may vet each next calendar date as previously disclosed until a new next calendar date is found that is within the customer commitment date (step 240) and is a transit date (step 245) where less than 1 day is needed for delivery.

In step 255, where the number of remaining needed days may be less than 1 day, then that carrier service level may remain a possible viable carrier service option and the process continues to step 260.

In step 260, method 200 may assess whether the “last needed transit date” is a “delivery day.” A “delivery day” refers to any day when a carrier service level can complete delivery by transferring custody of the shipment to a consignee/recipient. “Delivery days”, like other terms described above, may be negotiated and derived from the contracts between carriers and shippers like pickup dates and transit days/dates.

“Delivery days” may be defined in terms of a specific date, day(s) of the week or day and time of the week when a carrier/carrier service level will transfer custody of a shipment to a consignee/recipient (“inclusions”) (e.g., “from Monday and Friday between the hours of 8am-5pm”). “Delivery days”, alternatively, may be defined in terms of a specific date, day(s) of the week or day and time of the week when a carrier/carrier service level will not transfer custody of a shipment to a consignee/recipient (“exclusions”) (e.g., “any day, except Thursdays”). Contract terms may also selectively include/exclude include holidays and weekends as delivery days. In principle, if a carrier/carrier service level can transit a shipment from an origin to a destination prior to or on a customer commitment date, the last needed transit day is checked to ensure that the carrier service level will deliver the shipment that day.

At 260 the last needed transit day may be compared to the delivery day(s)/dates defined by contract. For any carrier service level where the last needed transit day is a delivery date, the carrier service level may be marked as successful at 280. For any carrier service level where the last needed transit day is not a delivery date, method 200 may proceed to step 265.

At 265, the calendar date may be moved forward to the next calendar date. At 270, method 200 may assess whether the next calendar date is after the customer commitment date. Where the next calendar date is not after the customer commitment date, method 200 reverts to step 260 to determine if the next calendar date is a delivery date and continues this iteration until it finds a calendar date that is within the customer commitment date and is a delivery date and the loop exits in step 280, where the carrier/service level may be marked as successful.

If the next calendar date of a carrier service level is determined to be after the customer commitment date at 270, that carrier service level may be marked as failed in step 275.

At 220, the same process may iterate through other carrier service levels to be evaluated until, at 285, those carrier service levels marked as successful in step 280 may be compared to identify a carrier service level to recommend to the user. For example, the successful carrier service level having the lowest total cost may be selected. As another example, a combination of shortest transit time and cost may be used to select recommended carrier service level, such as where multiple carrier service levels incur the same cost but have different transit times.

At 290, method 200 may return the results of its analysis and may report a recommended carrier service level that may perform the shipment service requested within the customer commitment date and at the lowest cost, and method 200 may end in step 295. In some embodiments, multiple carrier service levels indicated as successful by method 200 may be provided to a user or to another electronic system or method for automatic selection. Alternatively, a single recommended carrier service level may be selected and provided to a user, or automatically implemented without further human involvement as a selected carrier service level for a particular shipment.

Results generated by method 200 may include output files, reports or electronic data, and may contain information that would represent no shipments may be completed within the customer commitment date.

The generation of results may be triggered by completion of method 200. Alternatively, the generation of results may be configurable based on a desired time that is dictated by an external source such as, e.g., by an initiator or a separate process. The generation of results also may be configurable based on a desired event that is dictated by an external source such as, e.g., by an initiator or a separate process. As one skilled in the art will recognize, results may be formatted to fit the requirements of the initiator or process.

In a specific example illustration of the disclosure of the present invention, on Monday, Dec. 19, 2016, at 1:00 pm, a shipper using an external client accesses the advanced date selection system of the present invention via the Internet and enters an order including the following customer shipment data requesting shipment of twelve (12) parcels from Brookfield, Wis. and delivery to Milford, Connecticut by Friday, Dec. 23, 2016 (the customer commitment date). Each parcel is 12″×12″×12″ in dimension and weighs 25 lbs.

Immediately upon receipt, the advanced date selection system inputs, confirms and/or updates the shipper's information in an advanced date selection database, and uses the customer shipment data to collect a list of prospective carriers/carrier service levels that may qualify to provide the requested shipping services in order to query service level cost information and time in transit from local data stores or internal services over a network or external third-party service providers over a network.

The advanced date selection system then calculates a pickup for each identified prospective carrier service level. The shipper pickup time in this illustration is 1:00 pm. As there are carrier service levels having “last trailer pull” times after the pickup time, Dec. 19, 2016 is the pickup date for this delivery. The pickup date is also confirmed to be within the customer commitment date, so the process continues.

At this juncture, the process algorithm decrements the number of transit days required to determine if there are enough transit days available between the pickup date and the customer commitment date to deliver the package. In this manner, the calendar date is moved forward to Dec. 20, 2016. December 20th is within the customer commitment date and is a transit day, and so the algorithm reduces the number of days needed in transit by 1. However, as more than one day remains to transit the shipment following this calculus, the calendar date is moved forward once more to Dec. 21, 2016.

December 21st is within the customer commitment date and is a transit day, and so the algorithm reduces the number of days needed in transit by 1. However, as more than one day remains to transit the shipment following this calculus, the calendar date is moved forward once more to Dec. 22, 2016. As December 22^{nd} also is within the customer commitment date and is a transit day, the algorithm reduces the number of days needed in transit by 1 once more. However, as more than one day remains to transit the shipment following this calculus, the calendar date is moved forward once more to Dec. 23, 2016.

At this juncture, December 23rd is within the customer commitment date and is a transit day, so the algorithm reduces the number of days needed in transit once more. However, at this juncture, the number is reduced to less than one (from zero), so the process queries whether Dec. 23, 2016 is a delivery day. As December 23rd is, in fact, a delivery date, the available carrier/carrier service levels are marked as successful, the one carrier/carrier service levels showing the lowest cost to complete the service is identified, and the identified carrier/carrier service level is returned to the shipper as the recommended service.

In another illustration, the same facts as above are assumed. However, in this instance, the available carrier service level is a ground service that requires five “time in transit” days, and Dec. 24, 2016 is an exclusion date. In this illustration, even though all days between the December 19th and December 23^{rd} are transit days, the service will fail when step 255 pushed into step 235 with a calendar date of December 24^{th}.

In yet another illustration, the same facts as above are assumed. However, in this instance, the available carrier service level is a ground service that requires four “time in transit” days, the carrier service level has a last trailer pull time of 12 pm noon, and Dec. 24, 2016 is an exclusion date. Given these facts, a shipment request that is generated at 3 pm will have a pickup day on Dec. 20, 2016, a first transit day that falls on December 21^{st}, a second transit day that falls on December 22^{nd}, a third transit day that falls on December 23^{rd}, and a fourth transit day, that is intended as the delivery day, that will fall on December 24^{th}. In this scenario, the service will fail when step 255 pushed into step 235 because the pickup date was pushed to the next day and December 24^{th} was a delivery exclusion date. Alternatively, if the same shipment request had been generated and shipped on December 19^{th} at 11:00 AM, the carrier service level would have been marked as successful and identified as a potential shipment service candidate.

According to an embodiment of the disclosed subject matter, an improved system is provided for dynamically and more accurately determining a parcel shipment delivery date including a network and at least one processor including memory coupled to the network. The processor may be configured to store and read carrier service level configurations including at least one of pickup dates, last trailer pull times, transit dates and delivery dates for each available carrier service, receive customer shipment requests, initiate requests and store responses for carrier service level cost information based upon the customer shipment requests, process the carrier service level configurations and carrier service level cost information to identify a lowest cost carrier service level capable of delivering the customer shipment within the customer commitment date, and transmit the identified available lowest cost carrier service level responsive to the customer shipment request.

According to this embodiment, the network of this improved system may include the Internet and may also include other networks such as a local area network. The customer shipment request received by the improved system may include at least one of a shipment origin, a shipment destination and shipment weights. The carrier service level configurations of the improved system may include at least one of pickup inclusion or exclusion dates, transit inclusion or exclusion dates, and delivery inclusion or exclusion dates. The carrier service level cost information of the improved system may include service level information and rate information, and the service level information may include time in transit information.

According to this embodiment, the processor of the improved system may transmit and receive requests for one or more carrier service level configurations and carrier service level cost information from one or more of a local data store, an internal service connected to the network or an external third-party service provider connected to the network. The carrier service level cost information of the improved system also may include one or more of last trailer pull times, pickup inclusion or exclusion dates, transit inclusion or exclusion dates, and carrier delivery inclusion or exclusion dates. The system processor may transmit and receive requests for one or more of carrier service level configurations and carrier service level cost information from third party providers.

According to an embodiment of the disclosed subject matter, an improved method is provided for dynamically and more accurately determining a carrier service capable of delivering a customer shipment within a customer commitment date at a lowest cost in response to a customer shipment request. The method may include one or more of the steps of storing and reading carrier service level configurations including at least one of pickup dates, last trailer pull times, transit dates and delivery dates for each available carrier service, receiving customer shipment requests over a network, and using at least one processor to process the customer shipment request. Processing of the customer shipment requests may include the steps of reading carrier service level configurations, initiating requests to and storing responses for carrier service level cost information based on the customer shipment requests, processing the carrier service level configurations and carrier service level cost information to identify a lowest cost carrier service level capable of delivering the customer shipment within the customer commitment date, and transmitting the identified available lowest cost carrier service level responsive to the customer shipment request.

According to this embodiment, the customer shipment request may further include at least one of a shipment origin, a shipment destination and shipment weights. The carrier service level configurations also may include at least one of pickup inclusion or exclusion dates, transit inclusion or exclusion dates, and carrier delivery inclusion or exclusion dates. The carrier service level cost information also may include service level information and rate information, and the service level information also may include time in transit information. The processor also may transmit and receive requests for one or more carrier service level configurations and carrier service level cost information from one or more of a local data store, an internal service or an external service provider.

According to an embodiment of the disclosed subject matter, an improved method is provided for dynamically and more accurately determining a shipment delivery date by receiving a shipment origin date and time, gathering carrier service level configuration data containing one or more of last trailer pull times, pickup inclusion or exclusion dates, transit inclusion or exclusion dates, and carrier delivery inclusion or exclusion dates, gathering carrier service level time in transit information and generating a delivery date using the shipment origin date and time, and carrier service level configuration data and the time in transit information. In generating a delivery date, the method may include determining a shipment pickup date. In determining a shipment pickup date, the method may include comparing the shipment origin date and time with the carrier last trailer pull times, and pickup inclusion and exclusion dates. In determining a shipment pickup date, the method also may calculate the next available pickup date by comparing the shipment origin date with the carrier last trailer pull times, and pickup inclusion and exclusion dates. In generating a delivery date, the method may evaluate all available transit dates from the shipment pickup date using at least one of transit inclusion and exclusion dates and the number of required transit days identified by the carrier.

According to an embodiment of the disclosed subject matter, a system is provided where a non-transitory computer-readable medium may use processor-executable instructions stored therein and configured to cause a processor to store and read carrier service level configurations including at least one of pickup dates, last trailer pull times, transit dates and delivery dates for each available carrier service, receive over a network and store customer shipment requests, initiate requests and store responses for carrier service level cost information based upon the customer shipment requests, process the carrier service level configurations and carrier service level cost information to identify a lowest cost carrier service level capable of delivering the customer shipment within the customer commitment date, and transmit the identified available lowest cost carrier service level responsive to the customer shipment request.

The system network may comprise the Internet and also may include other networks such as a local area network. The customer shipment request also may include at least one of a shipment origin, a shipment destination and shipment weights. The carrier service level configurations also may include at least one of pickup inclusion or exclusion dates, transit inclusion or exclusion dates, and delivery inclusion or exclusion dates. The carrier service level cost information also may include service level information and rate information, and the service level information also may include time in transit information. The carrier service level cost information may also include one or more of last trailer pull times, pickup inclusion or exclusion dates, transit inclusion or exclusion dates, and carrier delivery inclusion or exclusion dates. The system processor also may transmit and receive requests for one or more of carrier service level configurations and carrier service level cost information from third party providers.

As previously disclosed, embodiments may allow for dynamically and more accurately determining a carrier capable of delivering a customer shipment within a customer commitment date at a lowest cost in response to a customer shipment request. Thus, the present disclosure provides techniques suitable for addressing the foregoing issues regarding dynamically and more accurately determining a carrier capable of delivering a customer shipment within a customer commitment date at a lowest cost in response to a customer shipment request, while operating within the technical requirements and limitations of existing shipping systems.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

What is claimed is:

1. A date selection system for dynamically determining a carrier service capable of delivering a customer shipment within a customer commitment date at a lowest cost in response to a customer shipment request, the system comprising:
at least one processor communicatively coupled to a memory, the processor configured to:
store and read carrier service level configurations including at least one data selected from the group consisting of last trailer pull times, pickup dates, delivery dates and transit dates for each available carrier service;
receive customer shipment requests;
initiate requests to and store responses for carrier service level cost information based upon the customer shipment requests;
process the carrier service level configurations and carrier service level cost information to identify a lowest cost carrier service level capable of delivering the customer shipment within the customer commitment date; and
transmit the identified available lowest cost carrier service level responsive to the customer shipment request.

2. The system of claim 1, wherein the customer shipment request further includes at least one item selected from the group consisting of: of a shipment origin, a shipment destination and shipment weights.

3. The system of claim 1, wherein the carrier service level configurations further include at least one item selected from the group consisting of:
pickup inclusion or exclusion days, transit inclusion or exclusion days, and delivery inclusion or exclusion days.

4. The system of claim 1, wherein the carrier service level cost information includes service level information and rate information.

5. The system of claim 4, wherein the service level information includes time in transit information.

6. The system of claim 1, wherein the processor transmits and receives requests for carrier service level configurations, carrier service level cost information, or both.

7. The system of claim 6, wherein the requests are transmitted and received from one or more selected from the group consisting of: a local data store, an internal service connected to the network, and an external third-party service provider connected to the network.

8. An improved advanced date selection method for dynamically determining a carrier service capable of delivering a customer shipment within a customer commitment date at a lowest cost in response to a customer shipment request, the method comprising:
storing carrier service level configurations including at least one selected from the group consisting of: last trailer pull times, pickup dates, delivery dates and transit dates for each available carrier service;
receiving, over a network, the customer shipment request; and
reading the carrier service level configurations;
initiating requests to and storing responses for carrier service level cost information based upon the customer shipment requests;
processing the carrier service level configurations and carrier service level cost information to identify a lowest cost carrier service level capable of delivering the customer shipment within the customer commitment date; and
transmitting the identified available lowest cost carrier service level responsive to the customer shipment request.

9. The method of claim 8, wherein the customer shipment request further includes at least one selected from the group consisting of: a shipment origin, a shipment destination and shipment weights.

10. The method of claim 8, wherein the carrier service level configurations further include at least one selected from the group consisting of: pickup inclusion or exclusion dates, transit inclusion or exclusion dates, and delivery inclusion or exclusion dates.

11. The method of claim 8, wherein the carrier service level cost information includes service level information and rate information.

12. The method of claim 11, wherein service level information includes time in transit information.

13. The method of claim 8, wherein the processor transmits and receives requests for one or more of carrier service level configurations and carrier service level cost information from one or more of a local data store, an internal service or external third-party service provider.

14. A date selection method for dynamically determining a shipment delivery date, the method comprising:
receiving a shipment origin date and time;
gathering carrier service level configuration data comprising one or more selected from the group consisting of: last trailer pull times, pickup inclusion or exclusion dates, transit inclusion or exclusion dates, and carrier delivery inclusion or exclusion dates;
gathering carrier service level time in transit information; and
generating a delivery date using the shipment origin date and time, carrier service level configuration data and the time in transit information.

15. The method of claim 14, wherein the step of generating a delivery date further comprises the step of determining a shipment pickup date.

16. The method of claim 15, wherein the step of determining the shipment pickup date further comprises the step of comparing the shipment origin date and time with the carrier last trailer pull times, and pickup inclusion and exclusion dates.

17. The method of claim 15, wherein the step of determining the shipment pickup date further comprises the step of calculating the next available pickup date by comparing the shipment origin date with the carrier last trailer pull times, and pickup inclusion and exclusion dates.

18. The method of claim 14, wherein the step of generating a delivery date further comprises evaluating all available transit dates from the shipment pickup date using at least one of transit inclusion and exclusion dates and the number of transit dates indentified by the carrier.

19. A non-transitory computer-readable medium, comprising:
processor-executable instructions stored therein and configured to cause a processor to:
store and read carrier service level configurations including at least one selected from the group consisting of: last trailer pull times, pickup dates, delivery dates and transit dates for each available carrier service;
receive over a network and store customer shipment requests;
initiate requests to and store responses for carrier service level cost information based upon the customer shipment requests;
process the carrier service level configurations and carrier service level cost information to identify a lowest cost carrier service level capable of delivering the customer shipment within the customer commitment date; and
transmit the identified available lowest cost carrier service level responsive to the customer shipment request.

20. The non-transitory computer-readable medium of claim 19, wherein the customer shipment request further includes at least one selected from the group consisting of a shipment origin, a shipment destination and shipment weights.

21. The non-transitory computer-readable medium of claim 19, wherein the carrier service level configurations further include at least one selected from the group consisting of: pickup inclusion or exclusion dates, transit inclusion or exclusion dates, and delivery inclusion or exclusion dates.

22. The non-transitory computer-readable medium of claim 19, wherein the carrier service level cost information includes service level information and rate information.

23. The non-transitory computer-readable medium of claim 22, wherein the service level information includes time in transit information.

24. The non-transitory computer-readable medium of claim 19, wherein the processor transmits and receives requests for one or more of carrier service level configurations and carrier service level cost information from one or more selected from the group consisting of a local data store, an internal service connected to the network, and an external third-party service provider connected to the network.
